(19) United States
(12) Patent Application Publication
(10) Pub. No.: US 2026/0301978 A1
(43) Pub. Date: Oct. 1, 2026

(54) SODIUM COOLED FAST REACTOR MECHANICAL HOLD DOWN AND DISCRIMINATION SYSTEM

(71) Applicant: TerraPower, LLC, Bellevue, WA (US)

(72) Inventor: Artem Aleshin, Newcastle, WA (US)

(73) Assignee: TerraPower, LLC, Bellevue, WA (US)

(21) Appl. No.: 19/182,548

(22) Filed: Apr. 17, 2025

Related U.S. Application Data
(60) Provisional application No. 63/660,993, filed on Jun. 17, 2024.

(51) Int. Cl. G21C 5/06; G21C 1/02; G21C 5/16

(52) U.S. Cl. CPC G21C 5/06; G21C 1/022; G21C 5/16

(57) ABSTRACT

A nuclear reactor is designed and constructed to withstand seismic events. A mechanical hold down and discriminator may be provided as cooperating structure between the core receptacle and a nozzle of a core assembly. One or more receivers may be formed on the nozzle that cooperate with corresponding protrusions in a core receptacle. As the nozzle is inserted into the receptacle, the protrusion engages with the receiver to inhibit unintentional withdrawal of the nozzle from the receiver. A first pattern of receivers on a nozzle may align with a first pattern of protrusions within a receptacle to enable the nozzle to fit within a first receptacle. A second pattern of receivers formed on a second nozzle may inhibit the second nozzle from being inserted into the first receptacle and thereby provide a discrimination feature to ensure proper core assemblies are located in the correct location within a nuclear reactor core.

### CROSS REFERENCE

The present application claim benefit of priority to U.S. Provisional Patent Application No. 63/660,993, filed Jun. 17, 2024, titled “SODIUM COOLED FAST REACTOR MECHANICAL HOLD DOWN AND DISCRIMINATION SYSTEM,” the entire contents of which is hereby incorporated by reference.

### GOVERNMENT LICENSE RIGHTS

This invention was made with government support under DOE Cooperative Agreement No. DE-NE0009054 awarded by the U.S. Department of Energy. The government has certain rights in the invention.

### FIELD OF THE DISCLOSURE

This disclosure is directed to a mechanical hold down and discrimination system for nuclear core assemblies.

### BACKGROUND

In a sodium-cooled fast reactor (“SFR”), the main reactor components are a reactor vessel filled with a liquid sodium coolant and a reactor core. In some cases, an SFR includes core assemblies within the core, some of which contain fissile nuclear fuel. Once the fission chain reaction is initiated, heat builds within the nuclear reactor core. The reactor core is immersed in a pool of sodium coolant in the reactor vessel which draws the heat away from the reactor core.

The sodium coolant flows through the core assemblies, some of which may be fuel assemblies, by entering a nozzle of the core assembly and flowing about the fuel pins within the core assemblies to remove heat therefrom. A containment vessel surrounds the reactor vessel to prevent loss of sodium coolant in case of an unlikely leak from the reactor vessel. The pumps circulate primary sodium coolant between the reactor core and intermediate heat exchangers located in the pool. These heat exchangers may have non-radioactive intermediate sodium coolant on the other side of the heat exchanger. Heated intermediate sodium coolant may be circulated to a thermal storage system or directly to steam generators that generate steam to drive turbines of electrical generators.

The reactor core may contain several types of core assemblies, including core assemblies containing fissile fuel, fertile fuel, reflectors, neutron absorbers, among others. The forces of the flowing sodium on the core assemblies typically imparts an upward force on the core assemblies that tends to lift the core assemblies from their mounting sockets. In some cases, the pressure differential on the core assemblies from the flowing sodium imparts sufficient lifting force on the core assemblies that one or more core assemblies may lift out of the mounting receptacle. If a core assembly lifts out of its socket, a cascade of events is likely to occur, which may even include the loss of control of the nuclear reaction. For instance, the assembly can be starved of coolant, which can increase the temperature of the assembly rapidly.

In some SFR nuclear reactor designs, an upper hold down is provided to constrain the core assemblies from lifting out of their receptacles. However, an upper constraint adds complexity and, by fixing an upper limit of the core assemblies, invites the core assemblies to bow in response to thermal stresses. Moreover, the core assemblies are formed to have the same geometry and are thus interchangeable at locations within the core and, because they are submerged in the pool of sodium coolant, they cannot be identified by visual inspection methods.

It would therefore be advantageous if the core assemblies could be held down without adding complexity, constraining an upper limit of the core, and could be identified without visual inspection techniques to ensure that the correct core assembly is positioned in the correct location and in the correct orientation within the core. These, and other advantages, will become apparent to those of skill in the art by reference to following description, figures, and claims.

### SUMMARY

According to some embodiments, A mechanical core assembly hold down system for a nuclear reactor includes a core assembly having an inlet nozzle, the nozzle generally cylindrical having a sidewall; one or more receivers formed into the sidewall of the nozzle; a receptacle positioned within a core of the nuclear reactor, the receptacle generally cylindrical and configured to accept the nozzle of the core assembly; and a protrusion formed radially inwardly within the receptacle, the protrusion configured to fit within the one or more receivers of the nozzle when the nozzle is fully seated within the receptacle.

In some cases, the one or more receivers comprises a pocket formed in the sidewall of the nozzle. The one or more receivers may include a pair of parallel slots and a portion of material in between the parallel slots having a reduced stiffness than the portion of material without the slots. The material in between the parallel slots may deform resiliently in response to a force from the protrusion, and the parallel slots may form sidewalls that capture the protrusion to inhibit rotation movement of the core assembly.

In some cases, the receiver is a first receiver, and the system may further include a second receiver formed in the sidewall of the nozzle, the first receiver and second receiver forming a first pattern of receivers on the nozzle.

In some cases, a second core assembly has a second nozzle, the second nozzle having a third receiver and a fourth receiver forming a second pattern of receivers on the second nozzle, the second pattern of receivers different from the first pattern of receivers.

In some embodiments, the receptacle is a first receptacle and wherein the protrusion is a first protrusion and further comprising a second protrusion, the first protrusion and the second protrusion positioned at a first pattern of protrusions, the first pattern of protrusions corresponding with the first pattern of receivers. In this way, a receptacle within the nuclear reactor core can be configured with protrusions that cooperate with the first pattern of receivers and not the second pattern of receivers. Thus, the cooperating protrusions and receivers can discriminate to inhibit certain core assemblies from being inserted into certain receptacles within the core.

In some instances, the protrusion comprises a lead-in ramp to facilitate insertion of the core assembly into the receptacle. Alternatively, or in addition, the protrusion may include a lead-out ramp configured to facilitate removal of the core assembly from the receptacle. Similarly, in some examples, the one or more receivers formed into the sidewall of the nozzle comprise a sloped surface to facilitate removal of the core assembly from the nozzle.

According to some embodiments, a mechanical core assembly hold down system for a nuclear reactor includes a core assembly having an inlet nozzle with a generally cylindrical first end. The system also includes a receptacle positioned within a core of the nuclear reactor, the receptacle configured to accept the first end of the inlet nozzle. A keying feature is formed on the first end of the inlet nozzle, the keying feature comprising a plurality of slots passing through a sidewall of the first end and a plurality of bottom slots formed in a bottom surface of the first end, the plurality of slots and bottom slots defining a spring. The system further includes a protrusion formed radially inwardly within the receptacle, the protrusion configured to engage with the spring of the keying feature when the inlet nozzle is fully seated within the receptacle, thereby providing a hold down force and discriminating the core assembly.

In some embodiments, the plurality of slots are formed in pairs, each pair of slots aligned with a corner of a hexagonal portion of a second end of the inlet nozzle. In other embodiments, the keying feature comprises a plurality of pockets formed in the sidewall of the first end of the inlet nozzle.

The protrusion may comprise an inclined lead-in ramp, a land, and a lead-out ramp. The receptacle may include be a bypass tube formed of a material selected from the group consisting of 304 stainless steel, 304H stainless steel, 316 stainless steel, 216H stainless steel, Inconel, and grade 91 steel.

In certain embodiments, the protrusion is configured to engage the spring of the keying feature to provide the hold down force to the core assembly upon a reduction in a hydraulic hold down force on the core assembly. The plurality of slots formed in the first end of the inlet nozzle can be configured to provide rotational fixity to the core assembly within the receptacle.

The protrusion may be positioned at a location about an inner circumference of the receptacle corresponding to a position of the keying feature on the first end of the inlet nozzle, thereby discriminating the core assembly and ensuring the core assembly is positioned at a predetermined location and/or a predetermined rotational orientation within the core of the nuclear reactor.

In some cases, the keying feature formed on the first end of the inlet nozzle and the protrusion formed within the receptacle are configured to cooperate such that a force required to insert the inlet nozzle into the receptacle is less than a force required to remove the inlet nozzle from the receptacle.

According to some embodiments, a method of installing a core assembly in a nuclear reactor is provided. The method includes providing a core assembly with an inlet nozzle having a keying feature formed on a sidewall of its first end, and providing a receptacle within the reactor core, the receptacle having a protrusion formed radially inwardly. The keying feature of the inlet nozzle is aligned with the protrusion of the receptacle, and the first end of the inlet nozzle is inserted into the receptacle such that the protrusion engages with the keying feature. An insertion force is applied to the core assembly until the inlet nozzle is fully seated within the receptacle, whereby the engagement between the protrusion and the keying feature provides a hold down force to the core assembly.

In some embodiments, the keying feature includes slots passing through the sidewall of the first end and bottom slots formed in a bottom surface of the first end, defining a spring. Inserting the inlet nozzle into the receptacle deforms the spring with the protrusion. Aligning the keying feature with the protrusion may involve rotating the core assembly about its longitudinal axis until the keying feature is positioned to receive the protrusion.

The keying feature and protrusion can be configured such that the insertion force required to fully seat the inlet nozzle is less than the removal force required to unseat it. The method may further include providing a second core assembly with a different keying feature pattern and attempting to insert it into a receptacle with a mismatched protrusion pattern, thereby preventing full seating of the second core assembly.

The method may also include operating the nuclear reactor such that the core assembly is subjected to a hydraulic hold down force from coolant flowing through the inlet nozzle, while maintaining engagement between the protrusion and keying feature to provide a supplementary hold down force in case of a reduction in the hydraulic hold down force.

Creating the keying feature on the inlet nozzle may involve machining slots through the sidewall and bottom surface of the first end. Similarly, forming the protrusion within the receptacle can include machining an inner surface of the receptacle to create an inclined lead-in ramp, a land, and a lead-out ramp.

According to some embodiments, a method of installing a core assembly in a nuclear reactor includes the steps of providing a core assembly with an inlet nozzle having a generally cylindrical first end. The first end includes slots formed through its sidewall and bottom slots formed in its bottom surface, collectively defining a spring. A receptacle is provided within the reactor core, having a protrusion formed radially inwardly. The protrusion includes an inclined lead-in ramp, a land, and a lead-out ramp.

To install the core assembly, the slots of the inlet nozzle are aligned with the protrusion of the receptacle by rotating the core assembly about its longitudinal axis. The first end of the inlet nozzle is then inserted into the receptacle, causing the lead-in ramp of the protrusion to engage with the spring and deform it. An insertion force is applied until the inlet nozzle is fully seated and the land of the protrusion engages with the spring, providing a hold down force to the core assembly.

In some embodiments, the slots are formed in pairs, each pair of slots may be aligned with a corner of a hexagonal portion of the inlet nozzle's second end. The spring and protrusion may be configured such that the insertion force is less than the removal force required to overcome the engagement between the protrusion's land and the spring.

During reactor operation, coolant flows through the inlet nozzle, applying a hydraulic hold down force to the core assembly. The engagement between the protrusion and spring provides a supplementary hold down force if the hydraulic force is reduced.

The method may also enable assembly discrimination. For example, a first receptacle with a specific protrusion pattern will prevent full seating of a second core assembly having a different spring pattern, ensuring proper assembly placement.

The slots and bottom slots in the inlet nozzle can be formed by machining processes like milling, drilling, or electrical discharge machining. Similarly, the protrusion within the receptacle can be formed by turning, milling, or electrical discharge machining.

To remove the core assembly, a removal force greater than the hold down force is applied, causing the lead-out ramp of the protrusion to deform the spring and allow withdrawal of the inlet nozzle from the receptacle.

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

FIG. 1 illustrates, in a block diagram form, some of the basic components of a sodium-cooled fast reactor, in accordance with some embodiments.

FIG. 2 is a schematic sectional view of a core of a sodium-cooled fast reactor, in accordance with some embodiments.

FIG. 3 is an exploded view of a core assembly, in accordance with some embodiments.

FIG. 4 is an enlarged sectional view of an inlet nozzle and core support structure interface, in accordance with some embodiments.

FIG. 5 illustrates an inlet nozzle, in accordance with some embodiments.

FIG. 6 illustrates a bottom view of an inlet nozzle, in accordance with some embodiments.

FIG. 7 illustrates a close-up elevational view of a lower end of an inlet nozzle showing slots and bottom slots, in accordance with some embodiments.

FIG. 8 illustrates a close-up elevational view of an inlet nozzle having pockets formed therein, in accordance with some embodiments.

FIG. 9 illustrates a cross-sectional view of a bypass tube and receptacle, illustrating protrusions configured to cooperate with an inlet nozzle, in accordance with some embodiments.

FIG. 10 illustrates a cross-sectional view of an inlet nozzle inserted into a receptacle with the cooperating structure engaged, in accordance with some embodiments.

### DETAILED DESCRIPTION

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

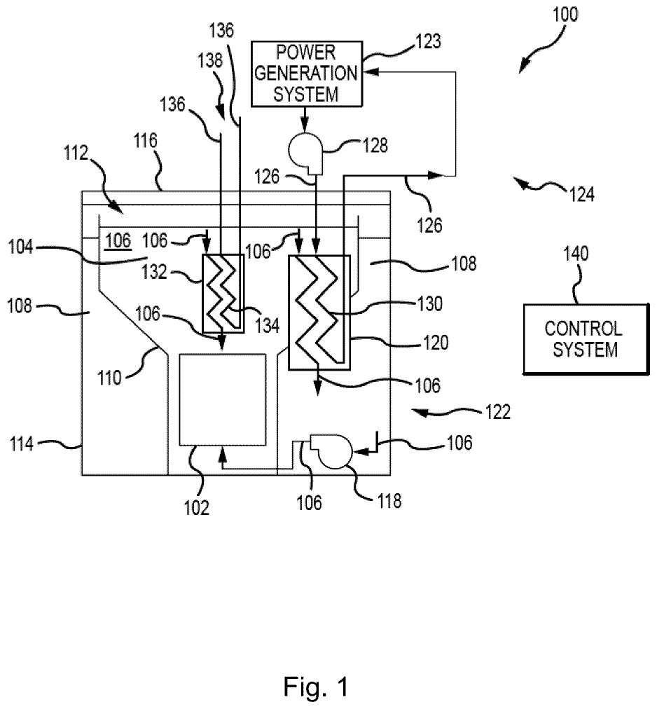

FIG. 1 illustrates, in a block diagram form, some of the basic components of a sodium-cooled fast reactor (SFR) fission plant 100. While an SFR may be used through the description as an example type of reactor technology, it should be appreciated that the concepts presented herein may be equally applicable to other types of reactors. In some cases, the concepts presented in the following description are directly appliable to other forms of sodium-cooled fast reactors (SFRs), such as, for example, traveling wave reactors, modular reactors, micro reactors, among others, and the disclosure and appended claims should not be limited to any specific nuclear reactor, fuel source, coolant type, or reactor architecture.

In general, the SFR fission plant 100 includes a reactor core 102 containing a plurality of core assemblies (not shown). The core 102 is disposed within a pool 104 holding a volume of liquid sodium coolant. The pool 104 nearer an upper portion of the reactor vessel is referred to as a hot pool and has a sodium temperature higher than that of a surrounding cold pool 108 that is nearer the lower portion of the reactor vessel (due to the energy generated by the fuel assemblies in the reactor core 102), which also contains liquid sodium coolant. The hot pool 104 is separated from the cold pool 108 by the redan 110. The sodium coolant flows through the reactor vessel along a flow path 106, both by natural circulation since the hotter sodium tends to rise and the colder sodium falls, as well as by a pump 118 that circulates the primary coolant. A headspace 112 above the level of the sodium coolant 106 is filled with an inert cover gas, such as argon. The reactor vessel 114 surrounds the reactor core 102, hot pool 104, and cold pool 108, and is sealed with a reactor head 116. The reactor head 116 provides various access points into the interior of the reactor vessel 114.

The size of the reactor core 102 is selected based on a number of factors, including the characteristics of the fuel, desired power generation, available reactor 100 space, and so on. Various examples of an SFR fission plant may be used in low power (around 300 MWe—around 500 MWe), medium power (around 500 MWe—around 1000 MWe), and high power (around 1000 MWe and above) applications, as required or desired. The performance of the reactor 100 may be improved by providing one or more reflectors, not shown, around the core 102 to reflect neutrons back into the core 102. Additionally, fertile and fissile nuclear assemblies may be moved (or “shuffled”) within and about the core 102 to control the nuclear reaction occurring therein.

The sodium coolant is circulated within the vessel 114 via a primary sodium coolant pump 118 along the primary coolant flow path 106. The primary coolant pump 118 draws sodium coolant from the cold pool 108 and injects it into a plenum below the reactor core 102. The coolant is forced upward through the core and is heated due to the fission reactions taking place within the reactor core 102. Heated coolant exits the upper end of the core 102 and enters an intermediate heat exchanger(s) 120 from the hot pool 104, and exits the intermediate heat exchanger 120 and re-enters the cold pool 108. This primary coolant loop 122 thus circulates sodium coolant entirely within the reactor vessel 114.

The intermediate heat exchanger 120 incorporates a segment of a closed liquid sodium loop that is physically separated from the primary sodium pools 104 and 108 at all times (i.e., intermediate and primary sodium are never co-mingled). The intermediate heat exchanger 120 transfers heat from the primary coolant loop 122 (fully contained within the vessel 114) to an intermediate coolant loop 124 (that is only partially located within the vessel 114). The intermediate heat exchanger 120 passes through the redan 110, thus bridging the hot pool 104 and the cold pool 108 (so as to allow flow of sodium in the primary coolant loop 122 therebetween). In an example, four intermediate heat exchangers 120 are distributed within the vessel 114. Alternatively, two or six intermediate heat exchangers 120 are distributed within the vessel 114, or some other number of heat exchangers 120 may be distributed about the reactor vessel 114.

The intermediate coolant loop 124 circulates sodium coolant 126 that passes through pipes into and out of the vessel 114, via the reactor head 116. An intermediate sodium pump 128 located outside of the reactor vessel 114 circulates the sodium coolant 126 to a power generation system 123. Heat is transferred from the sodium coolant 106 of the primary coolant loop 122 to the sodium coolant 126 of the intermediate coolant loop 124 in the intermediate heat exchanger 120. The sodium coolant 126 of the intermediate coolant loop 124 passes through a plurality of tubes 130 within the intermediate heat exchanger 120. These tubes 130 keep the sodium coolant 106 of the primary coolant loop 122 separate from the sodium coolant 126 of the intermediate coolant loop 124, while transferring heat energy therebetween.

A direct heat exchanger 132 extends into the hot pool 104 and provides cooling to the sodium coolant 106 within the primary coolant loop 122, usually in case of emergency. The direct heat exchanger 132 is configured to allow sodium coolant 106 to enter and exit the heat exchanger 132 from the hot pool 104. The direct heat exchanger 132 may have a similar construction to the intermediate heat exchanger 120, where tubes 134 keep separate the NaK (Sodium-Potassium) of the primary coolant loop 122 from the direct heat exchanger coolant (NaK) 136 of the direct reactor coolant loop 138, while transferring heat energy therebetween.

Other ancillary reactor components (both within and outside of the reactor vessel 114) include, but are not limited to, pumps, check valves, shutoff valves, flanges, drain tanks, etc., that are not depicted but would be apparent to a person of skill in the art. Additional penetrations through the reactor head 116 (e.g., a port for the primary coolant pump 118, inert cover gas and inspection ports, sodium processing, and cover gas ports, etc.) are not depicted. A control system 140 is utilized to control and monitor the various components and systems which make up the reactor 100.

Broadly speaking, this disclosure describes configurations that improve the performance of the reactor 100 described in FIG. 1. Specifically, examples, configurations, and arrangements of core assembly hold downs and discriminators are utilized to inhibit liftoff of core assemblies and allow additional certainty that the correct core assembly is located in the proper location and/or orientation. These features are shown and described in more detail below with reference to the following figures.

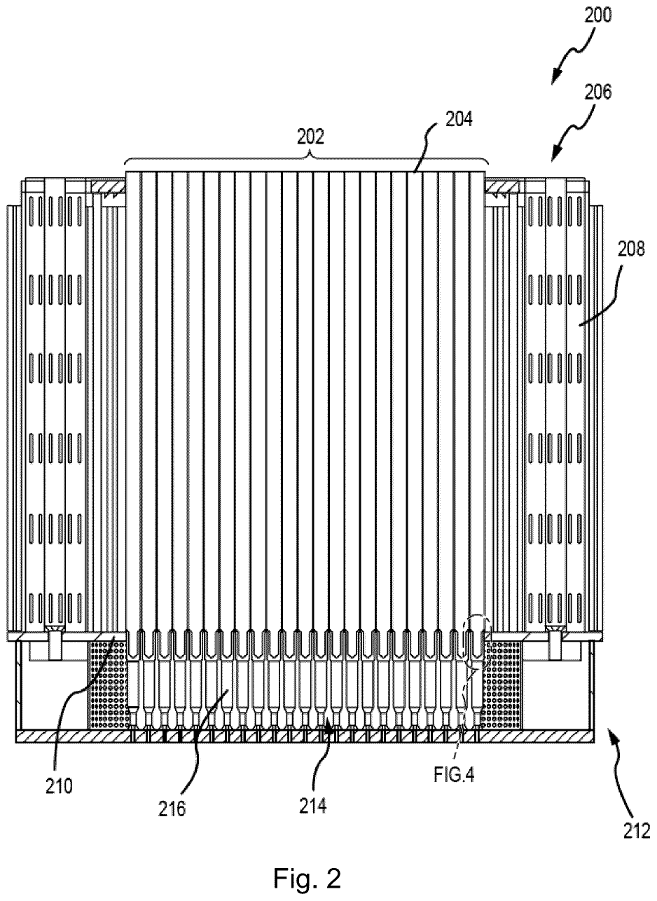

FIG. 2 is a schematic sectional view of a core 200 of an SFR. The core 200 is schematically shown and includes a central core region 202 having a plurality of core assemblies 204. The core assemblies 204 may include fissile nuclear fuel assemblies, fertile nuclear fuel assemblies, shield assemblies, reflector assemblies, control assemblies, standby shutdown assemblies, material testing assemblies, and other assembly types. In general, the contents of the assemblies (e.g., fissile material, control material, etc.) identifies the particular assembly. The components of the assemblies that hold such material may be identical, such as to facilitate shuffling the core assemblies around the core to any location, as desired. A peripheral core region 206 includes in-vessel storage pots 208. Throughout the life of the core 200, the fissile nuclear fuel assemblies and fertile nuclear fuel assemblies (as well as certain other assemblies) are shuffled between the central core region 202 and the peripheral core region 206. This is performed at various stages of the core life as required or desired to initiate, maintain, accelerate, control, or terminate nuclear reactions or power generation and/or for safety reasons.

The assemblies 204 are received by an upper plate 210 of a core support structure 212 at locations sized and configured to receive the core assemblies 204. Sodium coolant is pumped into a plenum 214 disposed below the upper plate 210 and flows upward into the core assemblies 204, where it is heated by the nuclear reactions taking place within the core 200. Structures that channel the flow of sodium through the core 202 and into the various assemblies are described below.

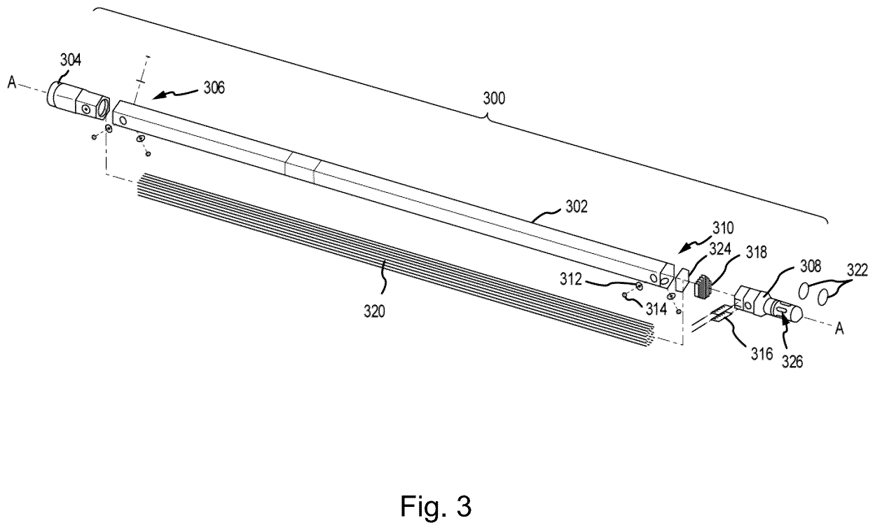

FIG. 3 is an exploded view of a core assembly 300. The assembly 300 includes an elongate duct 302 having an axis A. The duct 302 may have a hexagonal cross section. A handling socket 304 with an internal flow passage is secured to a first end 306 of the duct 302 and has internal or external features that allow it to be grasped by mechanisms within the reactor vessel to lift, lower, and otherwise move the assembly 300 into, out of, or within the core.

An inlet nozzle 308 is secured to a second end 310 of the duct 302. A plurality of bearing rings 312 and retaining rings 314 are used to attach the handling socket 304 and inlet nozzle 308 to the duct 302. A plurality of lock plates 316 (two in this example) and a plurality of pin strip rails 318 may be included proximate an end of the inlet nozzle 308. Together, the lock plates 316 and pin strip rails 318 connect the pin bundle 320 to the inlet nozzle 308. Seal rings 322 and a flow restrictor 324 may also be incorporated. The nozzle 308 defines a plurality of coolant inlet windows 326 that are in flow communication with an interior flow chamber (not shown) that extends through the nozzle 308. Thus, the windows 326 provide a path for sodium to flow into the nozzle 308 and into the duct 302 to flow around the pin bundle 320 disposed therein. Sodium flow continues out of the handling socket 304.

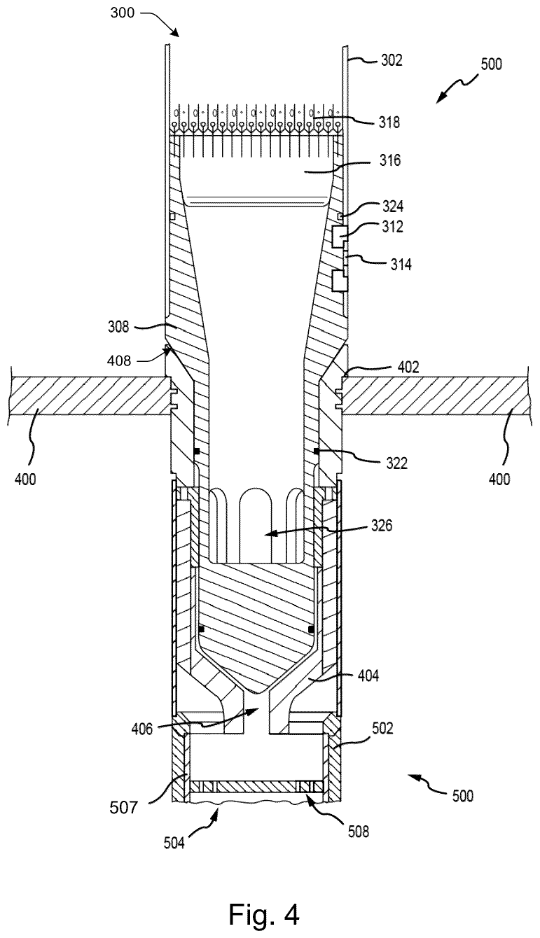

FIG. 4 is a sectional view of an example flow control system 500 showing the interface between an inlet nozzle 308 and core support structure 400. The inlet nozzle 308 is seated in and engaged with a receptacle 402 of the core support structure 400. A plurality of receptacles 402 may be located throughout the core and define locations for the core assemblies to be inserted. The nozzle 308 may have an oblique surface 408 that provides a funnel-shaped transition between a first diameter of the nozzle 308 and a second, larger diameter, of the duct 302. In some cases, the oblique surface 408 rests against the receptacle 402, while in other cases, the oblique surface 408 may be disposed above the receptacle 402. The interface between the oblique surface 408 and the receptacle 402 may be determined based upon the design of the receptacle and how far into the receptacle the core assemblies 300 are configured to be inserted. In some cases, there is a gap between the nozzle 308 and the receptacle 402 as will be described in further detail below.

A base of the receptacle 402 includes a bypass tube 404 that defines a passage 406 that provides a flow path for sodium to pass through the core assembly 300 and exit through the handling socket to the reactor sodium hot pool. The receptacle 402 may extend above the core support structure 400, or may be even therewith. Below the core support structure 400 is a coolant flow control system 500 that includes a masking element 502 and a flow stack 504 disposed therein. In this example, the masking element 502 is in the form of a sleeve. The flow stack 504 may include an outer housing 507 and at least one flow control assembly 508 disposed therein. The flow control system 500 is described in more detail below.

Suitable flow systems may utilize a standardized flow stack along with different masking sleeves at various locations below the core support structure. The masking features may be secured to or integral with the core support structure while the flow stacks may be integral with a core assembly or discrete therefrom. By utilizing a standardized flow stack, manufacturing costs, inter-assembly differences, and risk of incorrect assembly are decreased because of the standardized parts. A masking sleeve allows each flow stack to be used in any location, over a wide range of flow conditions such as those encountered in an SFR. The flow stack may be integral with a core assembly inlet nozzle or may be fixed within the masking sleeves. The flow stack may include multiple pressure stages and inlets for each stage. The masking sleeve may be disposed about the flow stack so as to create selective inlets to the flow stages. This arrangement allows for varying pressure drops according to the selective inlets exposed, which in turn dictates the number of pressure drop stages a flow will encounter. This allows for standardization of fuel assemblies while creating unique flow conditions for different core locations.

For an SFR, this may be advantageous as it allows a core assembly to be installed in, or relocated at any time to (e.g., shuffled to), a different core position while still receiving an appropriate metered flow rate (which can vary from location to location). In examples where the flow stacks are integral with the inlet nozzle, the flow stacks may be connected to a removable component (e.g., the core assembly). As such, lifetime effects (such as erosion damage) can be examined and mitigated as needed. For a “re-core” operation, where all core assemblies are exchanged for those of a different design, the replacement assemblies do not have to conform to the flow zones of the original core, allowing more flexibility in the design of future cores, if required or desired.

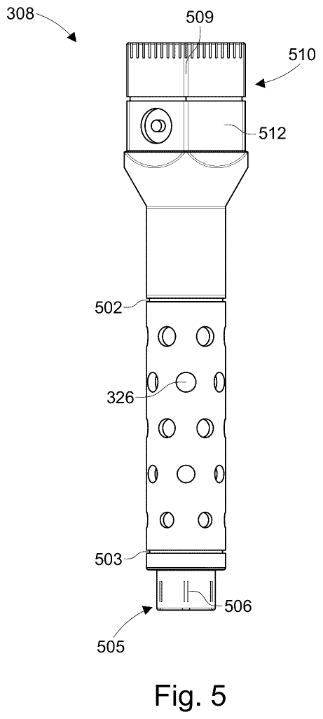

FIG. 5 illustrates an inlet nozzle 308, in accordance with some embodiments. As illustrated, the inlet nozzle 308 is shown in isolation, without the duct that would be attached during fabrication of the core assembly.

According to some embodiments, the nozzle 308 may have one or more annular grooves 503 that provide a mounting location for bearing rings, retaining rings, flow restrictors, and/or seal rings. A plurality of coolant inlet windows 326 may be provided to allow coolant to flow to an interior of the inlet nozzle 308 and around the pin bundle that is housed within the core assembly to which the nozzle 308 is attached.

The nozzle 308 may be formed to have a first end 505, which may be cylindrical in some cases. The first end 505 may be provided with a keying feature 506 that may be formed to provide a mechanical interface with the receptacle and may additionally provide a discriminator that inhibits a core assembly from being inserted into a wrong receptacle.

The keying feature 506, which may be a receiver configured to receive a cooperating structure, may be formed as any suitable feature, and in some cases, is formed as one or more slots, grooves, cutouts, pockets, bosses, springs, compliant mechanism, deformable portion, or other feature that can be configured to interface with cooperating structure within the receptacle.

As illustrated, the first end 505 is formed with a plurality of slots 506 that pass through a sidewall of the first end. The slots 506 may be formed to line up with a corner 509 of a hexagonal portion of a second end 510 of the nozzle, may be formed to line up with a flat 512 of the hexagonal portion of the second end 510 of the nozzle 308. In some cases, the slots are formed in pairs and a pair of slots are formed to coincide with a corner of the hexagonal portion of the second end 510. Therefore, twelve slots may be formed into the first end 505 of the nozzle 308.

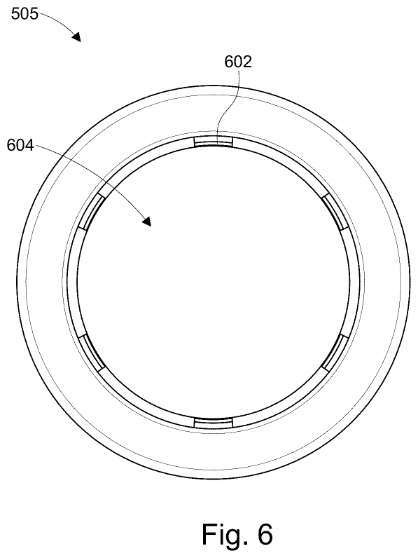

With additional reference to FIG. 6, in which a bottom view of the first end 505 of the nozzle 308 is illustrated, bottom slots 602 may be formed in the bottom surface 604 which can be designed to modify the stiffness of the material remaining between the slots 506.

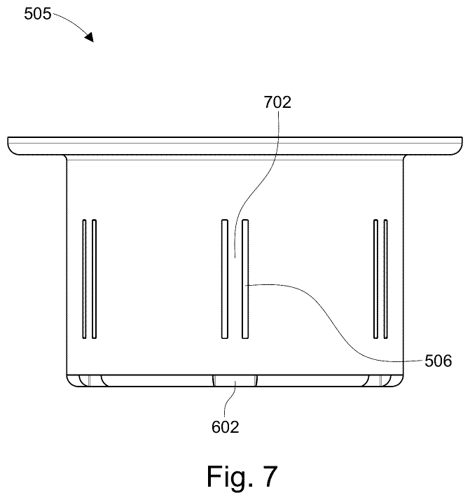

FIG. 7 illustrates a close-up view of the first end 505 of the nozzle showing the slots 506 and the bottom slots 602. In some cases, the slots 506 are formed through the sidewall of the first end 505, thereby leaving a strip of material in between the pair of slots, which may be deformed and acts as a spring 702. Similarly, the bottom slots 602 may be formed to coincide with the pair of slots 506 and may adjust the stiffness of the spring 702. As will be described hereinafter, a protrusion formed within the receptacle may deform the spring 702 and thereby provide a mechanical interference with withdrawal of the nozzle from the receptacle. Moreover, by providing the protrusion in the receptacle at desired locations around an inner circumference of the receptacle, the cooperating slots 506 and bottom slots 602 provide compliancy for allowing the core assembly to be located within the desired receptacle, so long as the spring 702 accurately lines up with the protrusions in the receptacle. In this way, the slots provide not only a hold down force on the core assembly, but also provide discrimination to ensure the correct core assembly is properly located within the core. Moreover, in some cases, the pattern of receivers and protrusions may be configured to ensure that a core assembly is inserted into the correct rotational orientation within a receptacle. In other embodiments, the receivers and protrusions are symmetrical to allow a core assembly to be inserted into the receptacle at any desired rotational orientation. However, it should be appreciated that because of the hexagonal packed nature of a nuclear reactor core, the core assemblies are generally inserted at an integer multiple of 60 degrees, such as 60 degrees, 120 degrees, 180 degrees, and so on so that a core assembly may pack closely with neighboring core assemblies.

As with all the embodiments herein, the number, pattern, and location of the springs 702 may be provided as desired. For example, the pair of slots 506 may be provided to align a spring 702 with each corner of the hexagonal duct, with the flat of each face of the hexagonal duct, or some other orientation to arrange the hexagonal duct in the core as desired. The number of springs may be 2, 3, 4, 5, 6, or some other number.

In some cases, the slots are formed to extend through the sidewall of the first end 505 of the inlet nozzle while in other embodiments, the slots do not extend all the way through the side wall. The design choice can be used to affect the stiffness of the spring and therefore the hold down force.

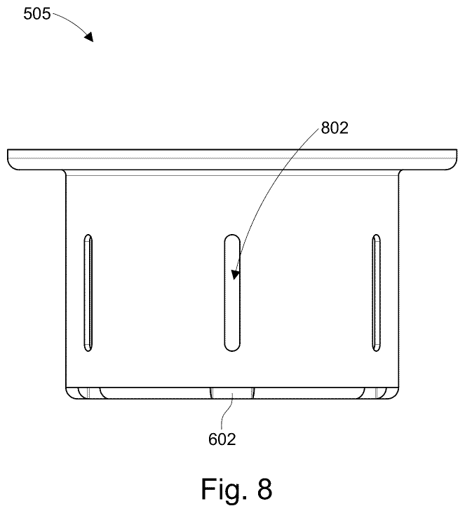

FIG. 8 illustrates a close-up view of another embodiment of an inlet nozzle first end 505 having pockets 802 formed therein. As with the previous embodiments, the location and number of the pockets may be varied and may include anywhere from 1 to 12 pockets or may include more pockets. In some examples, the pockets are formed in a repeating pattern that allows discrimination and also allow the core assembly to be located at a number of locations within the core. For example, a fertile fuel assembly may be formed with 6 pockets aligned with 6 corners of the fertile fuel assembly duct. A first receptacle located closer to an outer region of the core may have 6 corresponding protrusions that cooperate with the 6 pockets to provide both a hold down force and discrimination, as the 6 pockets must align with the 6 protrusions in the socket to allow the core assembly to fit within that particular location. Furthermore, the core assemblies may be designed so that only fertile fuel assemblies have the pocket configuration that utilizes 6 pockets aligned with the 6 corners of the hexagonal duct. As a result, there may be locations within the core that are designed to only allow fertile fuel assemblies to be inserted into that particular location. However, while certain locations may only allow fertile fuel assemblies to be inserted, there may be other locations that allow fertile fuel assemblies to be inserted. For example, a second receptacle location designed for fissile fuel assemblies may have 3 protrusions aligned at three of the corners of the hexagonal duct. In this case, a fertile fuel assembly may be located within the second receptacle configured to receive fissile fuel assemblies as desired. However, a reflector assembly may be configured differently and may not be able to be inserted into either the first receptacle or the second receptacle and is therefore prevented from being inserted into a receptacle designed for a fuel assembly.

As shown in FIG. 8, the pocket 802 may not extend all the way through the sidewall of the nozzle, although in some cases, it may be a through pocket and create a large slot configured to receive cooperating structure formed on the receptacle. With any of the embodiments described herein, the slots, pockets, holes, or other features may be formed by material removal processes, such as machining, cutting, drilling, melting, or other suitable method. In some cases, the pocket (e.g., receiver) may include inclined, sloped, a draft angle, or curved side walls between an outer periphery of the nozzle and the depth of the receiver. In some cases, the inclined sidewall of the receiver may facilitate removal of the core assembly from the core receptacle. In some embodiments, a sloped sidewall may be provided on a side of the receiver that facilitates removal of the core assembly from the receptacle.

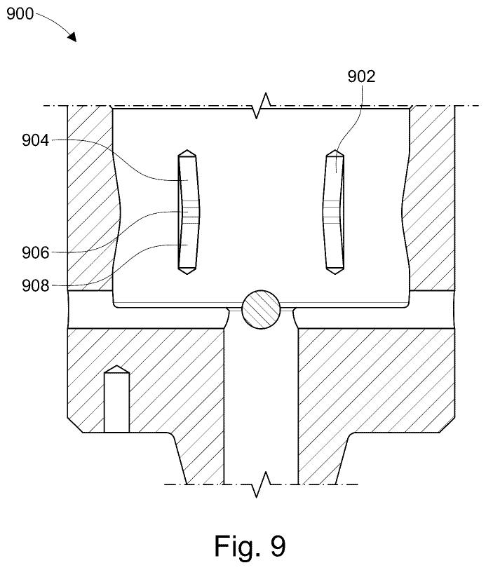

FIG. 9 illustrates a cross-sectional view of a bypass tube 900, which forms a part of the receptacle, that has protrusions 902 configured to cooperate with the springs or pockets of an inlet nozzle, in accordance with some embodiments. The protrusions 902 may be positioned at any location and at any orientation about an inner circumference of the bypass tube 900. While the description indicates that the bypass tube 900 has the protrusions 902, it should be readily apparent that other receptacle designs may include similar protrusions formed on other components of the receptacle to provide the benefits and advantages described herein. In other words, a component other than a bypass tube may have the protrusions formed thereon without departing from embodiments described herein.

The protrusions 902 may have an inclined lead in 904, such as a ramp that allows the inlet nozzle to gradually engage with the protrusion. The protrusions 902 may be formed such that the inclined lead in (e.g. lead-in ramp) reaches a maximum extension away from the bypass tube, that defines a land 906, which may then be followed by a lead-out ramp 908. In some cases, the protrusion may omit the lead-out ramp 908. The protrusions 902 may be arranged to be specific to a type of receptacle. For instance, a receptacle may be formed to accept a reflector assembly and may have an arrangement of protrusions 902 that cooperates with structure formed into the inlet nozzle of one or more reflector assemblies, which may be a different arrangement than other types of core assemblies.

The protrusions 902 may alternatively be formed to have additional shapes, which may include a curved surface, such as an arc, and may include both curved and straight components. In other examples, the protrusion may be semi-circular wherein the lead-in and lead-out are part of a circular arc. Of course, other suitable shapes may be used in order to cooperate with structure formed in or on the inlet nozzle to provide hold down force and/or discrimination features.

In some cases, the discrimination features are symmetric about the bypass tube 404, which allows for an assembly to be rotated to any desirable orientation and inserted into the receptacle. In some cases, the bypass tube is formed to accept a single type of core assembly.

The receptacle and the bypass tube may be formed of any suitable material, but in some cases, is formed of a material selected to last throughout the life of the nuclear reactor, which may be sixty years or more. The bypass tube may therefore be formed of a suitable steel, such as an ASME Section 3 division 5 steel, which may include, without limitation, 304 stainless, 304H, 316, 216H, Inconel, and grade 91 steel.

The protrusions may be formed in the receptacle during manufacturing. For instance, the receptacle may be machined, and the protrusion may be left by the machining process. In other cases, the receptacle may be formed in two halves such as a left/right or top/bottom, and the protrusions can be machined. In other cases, the receptacle may be formed from a suitable additive manufacturing process, such as 3D printing, and the protrusions can be formed during the printing step. In other cases, the protrusions may be attached to the receptacle, such as by welding.

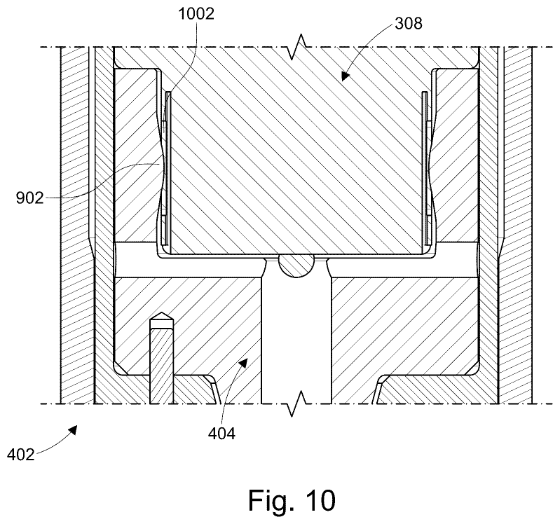

FIG. 10 illustrates a cross-sectional view of an inlet nozzle 308 inserted into a receptacle 402 and the cooperating structure is engaged. As illustrated, the protrusions 902 formed into the bypass tube 404 engage with the cooperating structure 1002 formed in the inlet nozzle 308. As described elsewhere herein, the cooperating structure 1002 may be slots, grooves, a spring, a compliant surface, or some other feature that captures the protrusion and provides both a hold down force and a discriminating feature. According to some embodiments, the mechanical hold down feature includes a receiver that captures a protrusion. For instance, the receiver may be any depression, indentation, slot, pocket, deformable portion, area of weakness, spring, or the like. In some cases, the cooperating structure include a male and a female portion that cooperate such that the male portion is captured by the female portion to increase the hold down force as compared to the absence of the cooperating structure. The protrusion may be any suitable feature and may include a ramp, a boss, and it may be rounded, compliant or deformable, or otherwise. In some cases, the protrusion may be located on either the receptacle or the nozzle. Similarly, the receiver may be formed on the receptacle or the nozzle. In many cases, the portion of the hold down force provided by the cooperating structure may primarily be due to friction and the force required to deflect the cooperating structure 1002 in order to overcome the hold down force.

The force required to insert or remove a nozzle from a receptacle may be tailored as desired. For instance, the distance of protrusion of the male portion may be lengthened or shorten to vary the contact force with the cooperating receiver. Similarly, the male portion may have an insertion ramp and a removal ramp that are asymmetrical, such that a force required to insert the nozzle into the receptacle is less than a force required to remove the nozzle from the receptacle. This may be provided by the geometry of the cooperating structure, such as by providing a ramp associated with the protrusion that has a lead-in ramp having a shallower incline than a lead-out ramp.

Furthermore, by controlling the force required to insert a nozzle into a socket, an in-vessel transfer machine within the nuclear reactor vessel can determine when a nozzle is fully seated into a receptacle by measuring the force exerted on the core assembly as it is inserted into a receptacle.

The receiver may be formed to vary the stiffness of the receiver, such as by varying wall thickness, length, depth, among others. The receiver may have different shapes, such as rectangular, ovoid, circular, among others.

During a seismic event, there may be vertical accelerations and it can be detrimental if the core assembles jump up and down or even worse, if they become unseated from the receptacle. In many cases, the primary seating force of the core assemblies results from hydraulic hold down. As primary coolant flows into the inlet nozzle a pressure differential provides hydraulic hold down to maintain the core assembly in its fully seated position. However, there are scenarios in which hydraulic hold down may be reduced or lost. As the primary coolant mass flow bypasses the inlet nozzle and impinges upon the outside of the nozzle, it reduces the seating force and may create a lifting force that may unseat a core assembly. In some cases, a core restraint system (and other components) are provided to at least partially provide assembly hold down. The systems and methods described herein provide additional mechanical hold down. In some of the examples and embodiments described herein, the mechanical hold down remains passive and does not engage or provide any hold down force unless and until the hydraulic hold down force is reduced, and a core assembly begins to lift off. As a core assembly begins to lift from its receptacle, the mechanical hold down components described herein engage and provide additional hold down force to maintain the core assembly in its seated position within the receptacle. In other words, the protrusion is configured to engage the receptacle to provide a hold down force to the core assembly only upon a reduction in a hydraulic hold down force on the core assembly. This may happen, for example, where a seal (e.g., piston ring seal) between the nozzle and the receptacle fails and the primary coolant mass flow bypasses the nozzle. Where hydraulic hold down is sufficient to maintain the core assembly in the fully seated position within the receptacle, the mechanical hold down system remains passive and may not provide any hold down force on the core assembly in some cases.

Moreover, core assemblies have the freedom to move and pivot about a point at the interface of the inlet nozzle and the receptacle. Fixity refers to the rotational stability of the core assemblies about this pivot point. Fixity is important for ensuring the safe and efficient operation of the reactor and promoting core lockup, in which the core assemblies bow toward the center of the core until they cannot bow further and are considered locked up.

If fixity in a nuclear reactor core is reduced, the core assemblies have more freedom to move, which promotes core lockup at a lower power to flow (P/F) ratio, and conversely, a higher fixity reduces reactivity and delays lockup. Moreover, if the fuel assemblies lose their stable positioning within the core, it can result in irregularities in the neutron flux distribution, potentially leading to hot spots or regions of excessive radiation. This not only affects the efficiency of power generation but also poses a risk of damaging the reactor components and fuel elements.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A mechanical core assembly hold down system for a nuclear reactor, comprising:
a core assembly having an inlet nozzle, the inlet nozzle being generally cylindrical and having a sidewall;
one or more receivers formed into the sidewall of the nozzle;
a receptacle positioned within a core of the nuclear reactor, the receptacle generally cylindrical and configured to accept the inlet nozzle of the core assembly; and
a protrusion formed radially inwardly within the receptacle, the protrusion configured to fit within the one or more receivers of the nozzle when the nozzle is fully seated within the receptacle.

2. The mechanical core assembly hold down system of claim 1, wherein the one or more receivers comprise a pocket formed in the sidewall of the inlet nozzle.

3. The mechanical core assembly hold down system of claim 1, wherein the one or more receivers comprise a pair of parallel slots and a portion of material in between the parallel slots having a reduced stiffness than the portion of material without the slots.

4. The mechanical core assembly hold down system of claim 3, wherein the portion of material is configured to deform inwardly in response to pressure applied by the protrusion.

5. The mechanical core assembly hold down system of claim 1, wherein the receiver is a first receiver, and further comprising a second receiver formed in the sidewall, the first receiver and second receiver forming a first pattern of receivers on the nozzle.

6. The mechanical core assembly hold down system of claim 5, further comprising a second core assembly having a second nozzle, the second nozzle having a third receiver and a fourth receiver forming a second pattern of receivers on the second nozzle, the second pattern of receivers different from the first pattern of receivers.

7. The mechanical core assembly hold down system of claim 6, wherein the receptacle is a first receptacle and wherein the protrusion is a first protrusion and further comprising a second protrusion, the first protrusion and the second protrusion positioned at a first pattern of protrusions, the first pattern of protrusions corresponding with the first pattern of receivers.

8. The mechanical core assembly hold down system of claim 1, wherein the protrusion comprises a lead-in ramp to facilitate insertion of the core assembly into the receptacle.

9. The mechanical core assembly hold down system of claim 1, wherein the protrusion comprises a lead-out ramp configured to facilitate removal of the core assembly from the receptacle.

10. The mechanical core assembly hold down system of claim 1, wherein the one or more receivers formed into the sidewall of the nozzle comprise a sloped surface to facilitate removal of the core assembly from the nozzle.

11. The mechanical core assembly hold down system of claim 1, wherein the nozzle comprises a bottom surface generally orthogonal to the sidewall and further comprising a hole formed through the bottom surface and aligned with the one or more receivers, the hole configured to reduce a stiffness of the nozzle at a location of the one or more receivers.

12. The mechanical core assembly hold down system of claim 1, wherein the protrusion is configured to engage the receptacle to provide a hold down force to the core assembly only upon a reduction in a hydraulic hold down force on the core assembly.

13. A mechanical core assembly hold down system for a nuclear reactor, comprising:
a core assembly having an inlet nozzle with a generally cylindrical first end;
a receptacle positioned within a core of the nuclear reactor, the receptacle configured to accept the first end of the inlet nozzle;
a keying feature formed on the first end of the inlet nozzle; and
a protrusion formed radially inwardly within the receptacle, the protrusion configured to engage with the keying feature when the inlet nozzle is fully seated within the receptacle, thereby providing a hold down force and discriminating the core assembly.

14. The mechanical core assembly hold down system of claim 13 wherein the keying feature comprises a plurality of slots passing through a sidewall of the first end and a plurality of bottom slots formed in a bottom surface of the first end, the plurality of slots and bottom slots defining a spring, wherein the plurality of slots are formed in pairs, each pair of slots aligned with a corner of a hexagonal portion of a second end of the inlet nozzle.

15. The mechanical core assembly hold down system of claim 14 wherein the protrusion is configured to engage the spring of the keying feature to provide the hold down force to the core assembly upon a reduction in a hydraulic hold down force on the core assembly.

16. The mechanical core assembly hold down system of claim 14 wherein the plurality of slots formed in the first end of the inlet nozzle are configured to provide rotational fixity to the core assembly within the receptacle.

17. The mechanical core assembly hold down system of claim 13 wherein the keying feature comprises a plurality of pockets formed in a sidewall of the first end of the inlet nozzle.

18. The mechanical core assembly hold down system of claim 13 wherein the protrusion comprises an inclined lead-in ramp, a land, and a lead-out ramp.

19. The mechanical core assembly hold down system of claim 13 wherein the protrusion is positioned at a location about an inner circumference of the receptacle corresponding to a position of the keying feature on the first end of the inlet nozzle, thereby discriminating the core assembly and ensuring the core assembly is positioned at a predetermined location within the core of the nuclear reactor.

20. The mechanical core assembly hold down system of claim 13 wherein the keying feature formed on the first end of the inlet nozzle and the protrusion formed within the receptacle are configured to cooperate such that a force required to insert the inlet nozzle into the receptacle is less than a force required to remove the inlet nozzle from the receptacle.
